(19) United States
(12) Patent Application Publication
(10) Pub. No.: US 2018/0345285 A1
(43) Pub. Date: Dec. 6, 2018

(54) SYSTEMS AND DEVICES FOR MICROFLUIDIC CARTRIDGE

(71) Applicant: SPECTRADYNE LLC, Rolling Hills Estate, CA (US)

(72) Inventors: Andrew N. Cleland, Chicago, IL (US); Jean-Luc Fraikin, Toronto (CA); Peter Meinhold, Santa Barbara, CA (US); Franklin Monzon, Rolling Hills Estates, CA (US)

(73) Assignee: SPECTRADYNE LLC, Rolling Hills Estate, CA (US)

(21) Appl. No.: 15/778,191

(22) PCT Filed: Nov. 22, 2016
(86) PCT No.: PCT/US2016/063421

§ 371 Date: May 22, 2018

Related U.S. Application Data
(60) Provisional application No. 62/260,052, filed on Nov. 25, 2015.

(51) Int. Cl. B01L 3/00; G01N 15/00

(52) U.S. Cl. CPC B01L 3/502761; B01L 3/502707; B01L 3/502715; G01N 15/00; B01L 2300/12; B01L 2300/0645; B01L 2300/0816; B01L 2200/12; B01L 2200/027

(57) ABSTRACT

Various embodiments disclosed herein comprise a microfluidic cartridge, comprising a molded polymer bonded to a flat surface, wherein the molded polymer comprises one or more openings for connecting to fluidic volumes. Also provided are methods of preparing a microfluidic cartridge, comprising placing a patterned micro-fabricated chip into a mold and filling the mold with a material in liquid or other shape-conforming form. Further disclosed herein are methods of analyzing a particle sample by using the microfluidic sample.

### FIELD OF THE INVENTION

The present invention relates generally to nanotechnology and, more particularly, to systems and devices for microfluidic instruments and analysis.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Applications of synthetic nanoparticles include cosmetics, photovoltaics and nanomedicine. Naturally occurring microparticles and nanoparticles mediate important physiological processes, and lethal viruses with diameters of about 50-150 nm kill millions of people annually. However, the practical development and use of nanoparticles is significantly constrained by a lack of practical tools capable of detecting and characterizing particles in this size range. Thus, there is a need in the art for novel and effective methods and related instruments for nanoparticle analysis.

### SUMMARY OF THE DISCLOSURE

Embodiments of the present disclosure comprise a microfluidic cartridge, comprising: a molded polymer bonded to a flat surface, wherein the molded polymer comprises one or more openings for connecting to fluidic volumes. In one embodiment, the microfluidic cartridge further comprises a micro-fabricated chip. In one embodiment, the flat surface further comprises one or more electrodes. In one embodiment, the one or more connections provide gas and/or fluid connections. In one embodiment, the molded polymer is an organic molded polymer. In one embodiment, the flat surface comprises a glass surface. In one embodiment, the one or more openings are adapted to introduce fluid to the cartridge without contacting a connected instrument. In one embodiment, the microfluidic cartridge further comprises microfluidic cartridge areas with different open volumes of fluid. In one embodiment, the cartridge permits multiple use, with the same or with different samples. In one embodiment, the fluidic volumes comprise microfluidic volumes. In one embodiment, the microfluidic cartridge is described by FIGS. 1-5 herein.

Embodiments of the present disclosure also comprise a method of preparing a microfluidic cartridge, comprising: placing a patterned micro-fabricated chip into a mold; and filling the mold with a material in liquid or other shape-conforming form. In one embodiment, the patterned micro-fabricated chip is patterned using advanced lithographic technology. In one embodiment, the material is an organic polymer. In one embodiment, the material is heat and/or time cured. In one embodiment, the patterned micro-fabricated chip is made from a silicon base. In one embodiment, the mold is described by FIG. 6 herein.

Embodiments of the present disclosure further comprise a method of analyzing a sample comprising particles, comprising: providing a microfluidic cartridge comprising a molded polymer bonded to a flat surface and using the microfluidic cartridge to analyze the sample, wherein the molded polymer comprises one or more openings for connections to fluidic volumes. In one embodiment, the sample comprises microparticles and/or nanoparticles. In one embodiment, the sample is a biological sample. In one embodiment, the microfluidic cartridge further comprises patterned metal electrodes. In one embodiment, the patterned metal electrodes are in contact with microfluidic volumes in some parts of the cartridge, and the patterned metal electrodes are not in contact with the microfluidic volumes in the rest of the cartridge.

### BRIEF DESCRIPTION OF THE FIGURES

Exemplary embodiments are illustrated in referenced figures. It is intended that the embodiments and figures disclosed herein are to be considered illustrative rather than restrictive.

FIG. 1 depicts, in accordance with embodiments herein, an example of an electrode configuration. An outline of the mold polymer 102 and a chip 104 are illustrated. In one embodiment, the chip 104 is made of glass.

FIG. 2 depicts, in accordance with embodiments herein, a transition crossover detail. In one embodiment, the contact electrode 110, and the electrode transition crossover detail 108 in the microfluidic cartridge are illustrated. The edge of the overlayed molded polymer 102 is illustrated by a dashed line.

FIG. 3 depicts, in accordance with embodiments herein, a fusible link detail, illustrating the contact of the electrodes, 110, to the fusible link 112.

FIG. 4 depicts, in accordance with embodiments herein, an example of a cartridge. (A) top perspective of the cartridge; and (B) side perspective of the cartridge. FIG. 4(a) illustrates the positions of the sealing ring 116, reservoir 118, port 120, and electrodes 110 are disclosed.

FIG. 4(b) illustrates the positions of the sealing ring 116 and reservoir 118.

FIG. 5 depicts, in accordance with embodiments herein, an example of a cartridge. The diagram demonstrates various examples of possible cartridge thickness dimensions and examples. In this embodiment, the buffer on the fluid resistor side 124, buffer on the nanoconstriction side 126, fluid in/out ports 120, analyte-in port 134, analyte-waste port 136, primary flow 132 of the fluid, particle detection flow, 138, nanoconstriction 122, and fluid resistor 130 are illustrated.

FIG. 6 depicts, in accordance with embodiments herein, an example of a mold 140, illustrating the machined insert 142, microfabricated insert 144, insert backing 146, insert backing spring 148, injection tube 150, and post 152. In one embodiment, the mold may be used in conjunction with various microfluidic devices and instruments described herein.

Other features and advantages of the invention will become apparent from the following detailed description, taken in conjunction with the accompanying drawings, which illustrate, by way of example, various embodiments of the invention.

### DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs. Hornyak, et al., Introduction to Nanoscience and Nanotechnology, CRC Press (2008); Singleton et al., Dictionary of Microbiology and Molecular Biology 3rd ed., J. Wiley & Sons (New York, N.Y. 2001); March, Advanced Organic Chemistry Reactions, Mechanisms and Structure 7th ed., J. Wiley & Sons (New York, N.Y. 2013); and Sambrook and Russel, Molecular Cloning: A Laboratory Manual 4th ed., Cold Spring Harbor Laboratory Press (Cold Spring Harbor, N.Y. 2012), provide one skilled in the art with a general guide to many of the terms used in the present application. One skilled in the art will recognize many methods and materials similar or equivalent to those described herein, which could be used in the practice of the present invention. Indeed, the present invention is in no way limited to the methods and materials described.

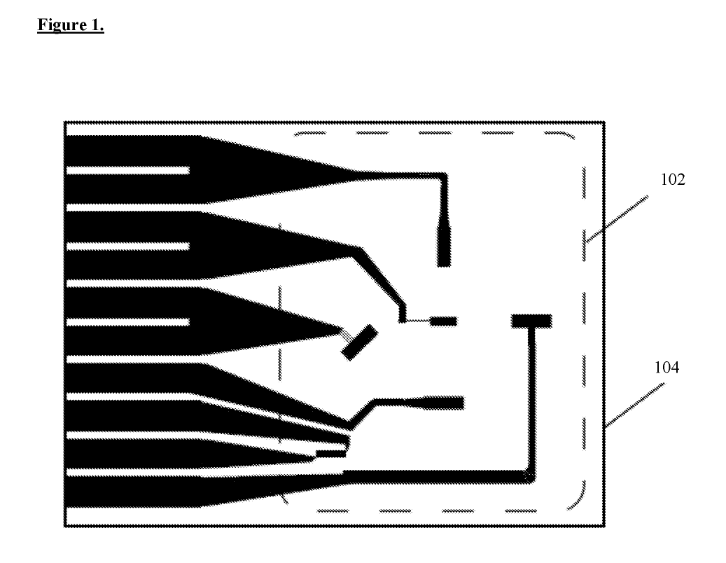

As disclosed herein, the inventors have developed a microfluidic cartridge, comprising a molded polymer bonded to a flat surface, wherein the molded polymer comprises one or more openings for connecting to fluidic volumes. The outline of the molded polymer 102 is illustrated in FIG. 1. In one embodiment, the microfluidic cartridge further comprises a micro-fabricated chip 104. In one embodiment, the flat surface further comprises one or more electrodes 110. In one embodiment, the one or more connections provide gas and/or fluid connections. In one embodiment, the molded polymer is an organic molded polymer. In one embodiment, the flat surface is glass. In one embodiment, the one or more openings are adapted to introduce fluid to the cartridge without contacting a connected instrument. In one embodiment, the microfluidic cartridge further comprises microfluidic cartridge areas with different open volumes of fluid. In one embodiment, the cartridge permits multiple use, with the same or with different samples. In one embodiment, the fluidic volumes comprise microfluidic volumes. In one embodiment, the microfluidic cartridge is described by FIGS. 1-5 herein.

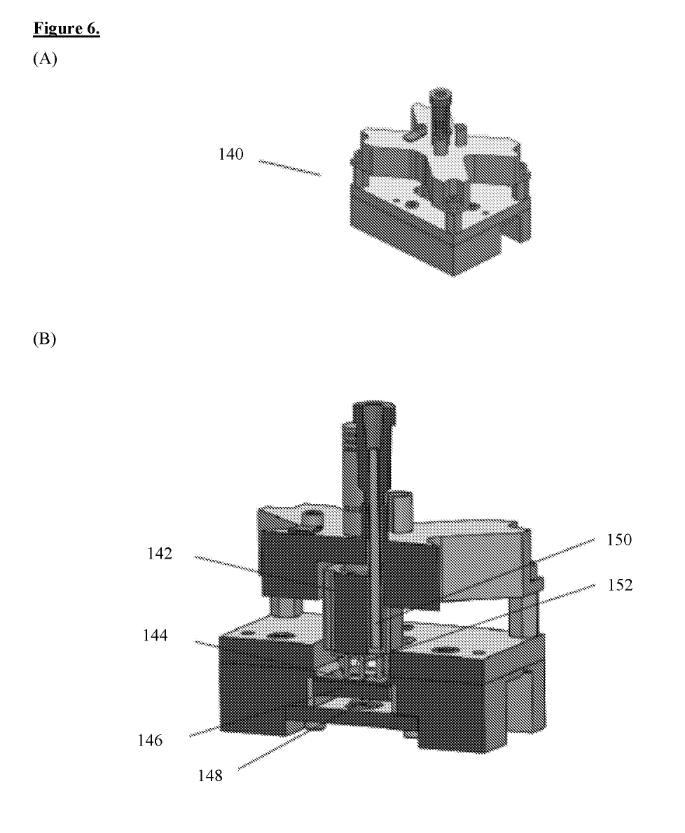

In one embodiment, disclosed herein is a method of preparing a microfluidic cartridge, comprising: placing a patterned micro-fabricated chip 104 into a mold; and filling the mold with a material in liquid or other shape-conforming form. In one embodiment, the patterned micro-fabricated chip 104 is patterned using advanced lithographic technology. In one embodiment, the material is an organic polymer. In one embodiment, the material is heat and/or time cured. In one embodiment, the patterned micro-fabricated chip 104 is made from a silicon base. In one embodiment, the mold is described by FIG. 6 herein.

In one embodiment, disclosed herein is a method of analyzing a sample comprising particles, comprising: providing a microfluidic cartridge comprising a molded polymer bonded to a flat surface and using the microfluidic cartridge to analyze the sample, wherein the molded polymer includes one or more openings for connections to fluidic volumes. In one embodiment, the sample comprises microparticles and/or nanoparticles. In one embodiment, the sample is a biological sample. In one embodiment, the microfluidic cartridge further comprises patterned metal electrodes 110. In one embodiment, the patterned metal electrodes 110 are in contact with microfluidic volumes in some parts of the cartridge, and the patterned metal electrodes 110 are not in contact with the microfluidic volumes in the rest of the cartridge.

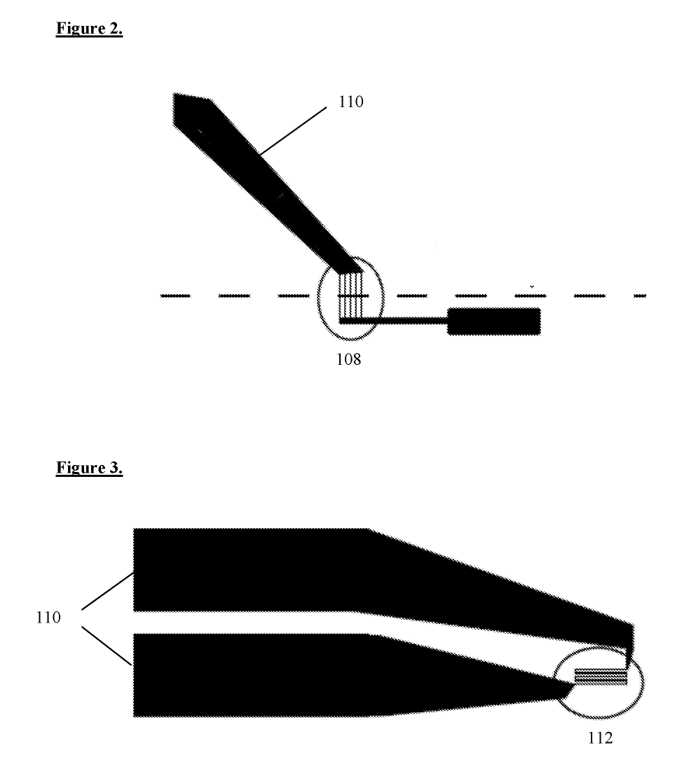

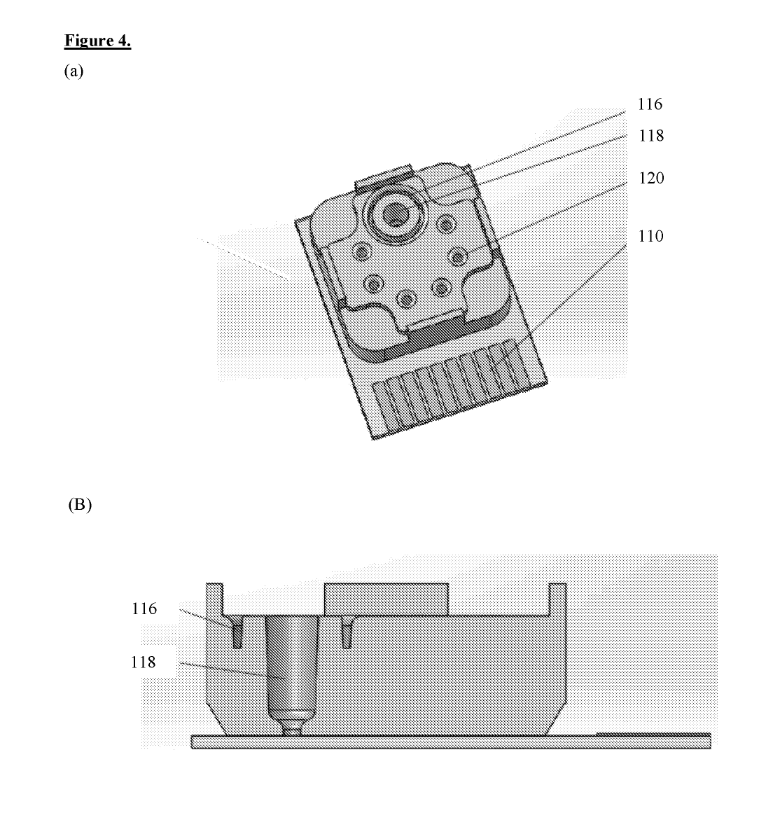

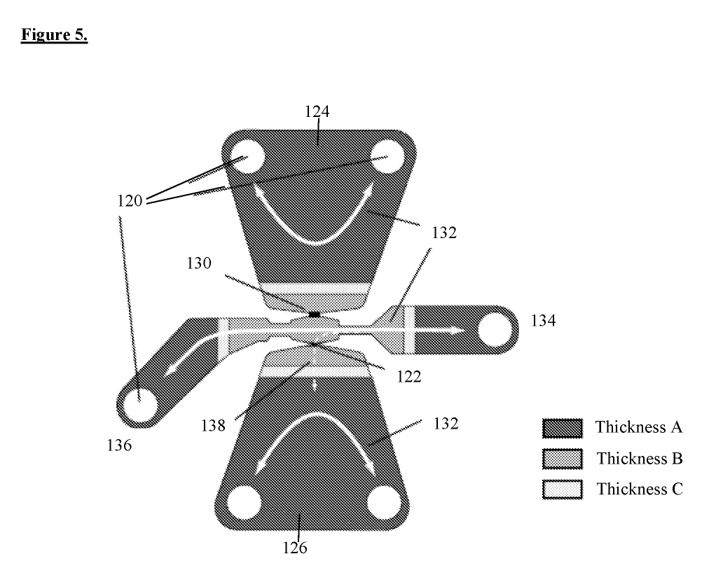

In one embodiment, FIG. 1 illustrates an outline of the mold polymer 102, and a chip 104. In one embodiment, FIG. 2 illustrates the contact electrode 110, and the electrode transition crossover detail 108 in the microfluidic cartridge disclosed herein. The edge of the overlayed molded polymer 102 is illustrated by a dashed line. In one embodiment, FIG. 3 discloses the contact of the electrodes, 110, to the fusible link 112. FIG. 4(a) illustrates another embodiment of the cartridge disclosed herein. In this embodiment, the positions of the sealing ring 116, reservoir 118, port 120, and electrodes 110 are disclosed. FIG. 4(b) illustrates another embodiment of the cartridge, disclosing the positions of the sealing ring 116 and reservoir 118. FIG. 5 provides an illustrative example of possible cartridge thickness. In this embodiment, the buffer on the fluid resistor side 124, and buffer on the nanoconstriction side 126 are shown. The fluid in/out ports 120 as well as the analyte-in port 134 and analyte-waste port 136 are also illustrated. The primary flow 132 of the fluid, the particle detection flow, 138, the nanoconstriction 122, and fluid resistor 130 for this embodiment are illustrated in FIG. 5. FIG. 5 further demonstrates various examples of possible cartridge thickness dimensions and examples. FIG. 6 illustrates the microfluidic cartridge mold 140, the machined insert 142, microfabricated insert 144, insert backing 146, insert backing spring 148, injection tube 150, and post 152.

In various embodiments herein, the present disclosure provides methods of preparing the microfluidic cartridge by use of a mold 140. For example, in one embodiment, the present disclosure provides a method of molding a microfluidic device using a microfabricated insert 144. In one embodiment, the present disclosure provides a method of fabricating a microfluidic cartridge using a one- or multi-part organic polymer, for example, or other material that is heat- and/or time-cured. The material in liquid form is used to fill a mold 140 that, in this implementation for example, includes a microfabricated chip 104 that is itself patterned using advanced lithographic technology. In another embodiment, the chip 104 can be made from a silicon base or other material compatible with this lithographic technology. In another embodiment, the chip 104 is patterned separately from the metal mold 140. In another embodiment, after the patterning of the chip 104 is complete, the chip 104 is placed and sealed into the mold 140 so that its features can be reproduced in the cured organic polymer or other material. The cured organic polymer or other material thus, for example, reproduces precisely all features in the mold 140 and the inset microfabricated chip 104.

In another embodiment, the present disclosure provides molded openings for gas and/or fluid connections to microfluidic volumes. For example, in one embodiment, the machined mold 140 used to form the organic polymer includes one or more machined or otherwise patterned posts that are used to form openings or ports 120 in the cured polymer, allowing the introduction of fluids or gases from the instrument into the microfluidic volumes patterned at the same time in the polymer. In another implementation, these opening or ports 120 pass from one surface of the cured polymer block to the opposite surface, the opposite surface being patterned, for example, by the microfabricated chip 104 described in Example 1 herein. In another embodiment, these openings or ports 120 are smooth cylinders passing entirely through the polymer. In another implementation, these openings or ports 120 may have other shapes than cylinders. In another implementation, these openings or ports 120 may pass in another direction through other surfaces of the organic polymer.

In another embodiment, the present disclosure provides molded openings for introducing fluid without contacting the instrument. In one embodiment, for example, the cartridge includes one or more volumes into which fluids may be placed prior to loading the cartridge in the instrument, allowing for example the introduction of fluid to be analyzed in such a way that this fluid does not contact the instrument, avoiding contamination of the fluid and of the instrument, and minimizing the volume of fluid required to be analyzed.

In another embodiment, the present disclosure includes a microfluidic channel design. For example, in one embodiment, as illustrated in FIG. 5, the microfabricated chip 104 used to pattern the microfluidic circuit can include in this implementation patterns with different heights in different parts of the design, yielding in the microfluidic cartridge areas with different open volumes of fluid. This can serve, for example, to greatly reduce the flow impedance, which serves to make the microfluidic volumes easier to fill and makes it easier to precisely control the pressure in these volumes. In another embodiment, the patterned areas can be made large where the same ease of filling and pressure control is needed. In another embodiment, the part of the microfluidic circuit in which the fluid to be analyzed is introduced can be connected through a low flow impedance connection to a “waste fluid” port 136, allowing the easy pressure control and filling of these volumes, separately from the volumes that are contacted only through the fluidic resistor 130 or the nanoconstriction 122. The volumes contacted through the fluidic resistor 130 or the nanoconstriction 122, in another embodiment, can be made from large area and/or large height patterns to reduce the flow impedance and make filling easier.

In another embodiment, relatively large volumes of fluid are moved into, through, or out of the cartridge via easy-to fill volumes created in conjunction with embodiments further described herein, without having to move the relatively large volumes of fluid through sections having high flow impedance.

In another embodiment, the fluid network is designed such that the fluid to be analyzed is passed through analyzing regions before contacting any other fluid, so it is not diluted or contaminated before analysis.

In another embodiment, the present disclosure provides an electrode design in the microfluidic cartridge. In one embodiment, the microfluidic cartridge is made by bonding a molded organic polymer or other material to a flat surface made of glass or other material. In another embodiment, the flat surface includes one or more patterned metal electrodes 110 for applying or sensing electrical voltages or currents, as illustrated in FIG. 1. These electrodes 110, for example, in some parts of the cartridge are enclosed in the microfluidic volumes and in other areas are not in contact with these volumes. In another embodiment, in the transition between the microfluidic volume and outside these volumes, the electrodes 110 can be split into smaller width electrodes 110 to improve the sealing of the molded material to the flat surface. This provides, for example, a more reliable sealing between the molded material and the flat surface, which otherwise sometimes does not seal well to the metal electrodes 110 and thus allows fluid to leak from the microfluidic volumes. In another embodiment, the width and number of these smaller electrode leads can be optimized to provide the best sealing while minimizing any deleterious electrical issues associated with this feature. In another embodiment, the microfluidic cartridge is as described in FIGS. 1 and 2 herein.

In another embodiment, the present disclosure provides a method of identifying a first use of a cartridge. For example, in one embodiment, the cartridges are made in a way that permits multiple use of a single cartridge, possibly with the same or with different analyte samples. The first use of the cartridge is however the only use where e.g. no cross-contamination between analytes can occur, where no pre-cleaning is necessary, where the cartridge filters are still pristine, etc. The inventors therefore have implemented, in one embodiment, a method to detect first use of a cartridge. For example, this method may involve including in the patterned metal on the glass part of the cartridge a fusible link 112 that can optionally be broken (made to change from low electrical resistance to very high electrical resistance) using electrical signals from the instrument. In another embodiment, the fusible link 112 can also be tested using electrical signals from the instrument to verify whether or not a particular cartridge has a broken fusible link 112 and thus whether the cartridge has been previously used. In another embodiment, the software in the instrument can then interact with the user of the instrument differently based on the outcome of this test. In another implementation, additional fusible links 112 on the cartridge electrodes 110, and corresponding wiring and circuitry in the instrument, allows the analogous detection of second, third, etc. uses of the cartridge. In another embodiment, for example, the microfluidic cartridge is as described in FIG. 3 herein.

Various embodiments herein describe microfluidic cartridges and devices, as well as method of preparing and use thereof, may be used to analyze and/or modify biological samples including samples comprising one or more nanoparticles. As readily apparent to one of skill in the art, any number of methods that involve analysis of nanoparticle or biological samples may be used in conjunction with various embodiments described herein, and the disclosure may also include methods of diagnosis, prognosis and/or treatment of a disease or condition in a subject. For example, in one embodiment, the present disclosure provides a method of diagnosing cancer in a subject by obtaining a sample from a subject, and then using a microfluidic cartridge comprising a molded polymer bonded to a flat surface wherein the molded polymer includes one or more openings for connections to microfluidic volumes to analyze the biological sample to determine the presence or absence of one or more biomarkers associated with susceptibility to cancer, and diagnosing susceptibility to cancer based on the presence of one or more biomarkers.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the selection of constituent modules for the inventive compositions, and the diseases and other clinical conditions that may be diagnosed, prognosed or treated therewith. Various embodiments of the invention can specifically include or exclude any of these variations or elements.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

### EXAMPLES

The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### Example 1

### Molding Microfluidic Device Using a Microfabricated Insert, 144

The microfluidic cartridge is fabricated using a one- or multi-part organic polymer or other material that is heat- and/or time-cured. The material in liquid form is used to fill a mold 140 that, in this implementation, includes a microfabricated chip 104 that is itself patterned using advanced lithographic technology. The chip 104 can be made from a silicon base or other material compatible with this lithographic technology, and is patterned separately from the metal mold. After the patterning of the chip 104 is complete, the chip 104 in this implementation is placed and sealed into the mold 140 so that its features can be reproduced in the cured organic polymer or other material. The cured organic polymer or other material thus reproduces precisely all features in the mold and the inset microfabricated chip 104.

### Example 2

### Molded Openings for Gas and Fluid Connections to Microfluidic Volumes

The machined mold used to form the organic polymer includes in this implementation one or more machined or otherwise patterned posts 152 that are used to form openings or ports 120 in the cured polymer, allowing the introduction of fluids or gases from the instrument into the microfluidic volumes patterned at the same time in the polymer. In one implementation these opening or ports 120 pass from one surface of the cured polymer block to the opposite surface, the opposite surface being patterned by the microfabricated chip 104 described in Example 1 herein. In one implementation these openings or ports 120 are smooth cylinders passing entirely through the polymer. In another implementation these openings or ports 120 may have other shapes than cylinders. In another implementation these openings or ports 120 may pass in another direction through other surfaces of the organic polymer.

### Example 3

### Molded Openings for Introducing Fluid without Contacting the Instrument

The cartridge includes one or more volumes into which fluids may be placed prior to loading the cartridge in the instrument, allowing for example the introduction of fluid to be analyzed in such a way that this fluid does not contact the instrument, avoiding contamination of the fluid and of the instrument, and minimizing the volume of fluid required to be analyzed.

### Example 4

### Microfluidic Channel Design

The microfabricated chip 104 used to pattern the microfluidic circuit can include in this implementation patterns with different heights in different parts of the design, yielding in the microfluidic cartridge areas with different open volumes of fluid. This can serve to greatly reduce the flow impedance, which serves to make the microfluidic volumes easier to fill and makes it easier to precisely control the pressure in these volumes. In the same or another implementation, the patterned areas can be made large where the same ease of filling and pressure control is needed. In the same or another implementation, the part of the microfluidic circuit in which the fluid to be analyzed is introduced can be connected through a low flow impedance connection to a “waste fluid” port, 136 allowing the easy pressure control and filling of these volumes, separately from the volumes that are contacted only through the fluidic resistor 130 or the nanoconstriction 122. The volumes contacted through the fluidic resistor 130 or the nanoconstriction 122, can in this or another implementation, be made from large area and/or large height patterns to reduce the flow impedance and make filling easier.

In one embodiment, relatively large volumes of fluid are moved into, through, or out of the cartridge via easy-to fill volumes created by a method such as the one described above, without having to move the relatively large volumes of fluid through sections having high flow impedance.

In one embodiment, the fluid network is designed such that the fluid to be analyzed is passed through analyzing regions before contacting any other fluid, so it is not diluted or contaminated before analysis.

### Example 5

### Electrode Design in Microfluidic Cartridge

In one implementation the microfluidic cartridge is made by bonding a molded organic polymer or other material to a flat surface made of glass or other material. In this implementation the flat surface includes one or more patterned metal electrodes 110 for applying or sensing electrical voltages or currents. These electrodes 110 in some parts of the cartridge are enclosed in the microfluidic volumes and in other areas are not in contact with these volumes. In the transition between the microfluidic volume and outside these volumes, the electrodes 110 can be split into smaller width electrodes to improve the sealing of the molded material to the flat surface. This provides a more reliable sealing between the molded material and the flat surface, which otherwise sometimes does not seal well to the metal electrodes 110 and thus allows fluid to leak from the microfluidic volumes. The width and number of these smaller electrode leads can be optimized to provide the best sealing while minimizing any deleterious electrical issues associated with this feature. For example, described as FIGS. 1 and 2 herein.

### Example 6

### A Method for Identifying First Use of a Cartridge

The cartridges are made in a way that permits multiple use of a single cartridge, possibly with the same or with different analyte samples. The first use of the cartridge is however the only use where e.g. no cross-contamination between analytes can occur, where no pre-cleaning is necessary, where the cartridge filters are still pristine, etc. The inventors therefore have implemented, in one implementation, a method to detect first use of a cartridge. This method involves including in the patterned metal on the glass part of the cartridge a fusible link 112 that can optionally be broken (made to change from low electrical resistance to very high electrical resistance) using electrical signals from the instrument. The fusible link 112 can also be tested using electrical signals from the instrument to verify whether or not a particular cartridge has a broken fusible link 112 and thus whether the cartridge has been previously used. The software in the instrument can then interact with the user of the instrument differently based on the outcome of this test. In another implementation, additional fusible links 112 on the cartridge electrodes 110, and corresponding wiring and circuitry in the instrument, allows the analogous detection of second, third, etc. uses of the cartridge. One example, of such a fusible link 112 is described in FIG. 3 herein.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.).

What is claimed is:

1. A microfluidic cartridge, comprising:
a molded polymer bonded to a flat surface,
wherein the molded polymer comprises one or more openings for connecting to fluidic volumes.

2. The microfluidic cartridge of claim 1, further comprising a micro-fabricated chip.

3. The microfluidic cartridge of claim 1, wherein the flat surface further comprises one or more electrodes.

4. The microfluidic cartridge of claim 1, wherein the one or more connections provide gas and/or fluid connections.

5. The microfluidic cartridge of claim 1, wherein the molded polymer is an organic molded polymer.

6. The microfluidic cartridge of claim 1, wherein the flat surface comprises a glass surface.

7. The microfluidic cartridge of claim 1, wherein the one or more openings are adapted to introduce fluid to the cartridge without contacting a connected instrument.

8. The microfluidic cartridge of claim 1, further comprising microfluidic cartridge areas with different open volumes of fluid.

9. The microfluidic cartridge of claim 1, wherein the microfluidic cartridge is adapted to permit multiple use with the same or with different samples.

10. The microfluidic cartridge of claim 1, wherein the fluidic volumes comprise microfluidic volumes.

11. The microfluidic cartridge of claim 1, as described by FIGS. 1-5 herein.

12. A method of preparing a microfluidic cartridge, comprising:
placing a patterned micro-fabricated chip into a mold; and
filling the mold with a material in liquid and/or other shape-conforming form.

13. The method of claim 12, wherein the patterned micro-fabricated chip is patterned using advanced lithographic technology.

14. The method of claim 12, wherein the material is an organic polymer.

15. The method of claim 12, wherein the material is heat and/or time cured.

16. The method of claim 12, wherein the patterned micro-fabricated chip is made from a silicon base.

17. The method of claim 12, wherein the mold is described by FIG. 6 herein.

18. A method of analyzing a sample comprising particles, comprising:
providing a microfluidic cartridge comprising a molded polymer bonded to a flat surface; and
using the microfluidic cartridge to analyze the sample,
wherein the molded polymer comprises one or more openings for connections to fluidic volumes.

19. The method of claim 18, wherein the sample comprises microparticles and/or nanoparticles.

20. The method of claim 18, wherein the sample is a biological sample.

21. The method of claim 18, wherein the microfluidic cartridge further comprises patterned metal electrodes.

22. The method of claim 21, wherein the patterned metal electrodes are in contact with microfluidic volumes in some parts of the cartridge, and the patterned metal electrodes are not in contact with the microfluidic volumes in the rest of the cartridge.
